(19) United States
(12) Patent Application Publication
(10) Pub. No.: US 2026/0087371 A1
(43) Pub. Date: Mar. 26, 2026

(54) APPARATUS AND METHODS FOR FEDERATED LEARNING OF A FIRST MACHINE-LEARNING MODEL, DEVICE AND METHOD FOR A DEVICE

(71) Applicant: Sony Group Corporation, Tokyo (JP)

(72) Inventors: Weiming ZHUANG, Tokyo (JP); Jingtao LI, Tokyo (JP); Lingjuan LYU, Tokyo (JP)

(73) Assignee: Sony Group Corporation, Tokyo (JP)

(21) Appl. No.: 18/893,069

(22) Filed: Sep. 23, 2024

(51) Int. Cl. G06N 3/098; G06N 3/045

(52) U.S. Cl. CPC G06N 3/098; G06N 3/045

(57) ABSTRACT

The federated learning of a first machine-learning model apparatus includes processing circuitry configured to generate a smaller second machine-learning model including a backbone and a decoder from the first machine-learning model. The processing circuitry is configured to perform at least one iteration of the following: (a) output the decoder of the second machine-learning model to one or more devices and for the first iteration of the at least one iteration further output the backbone of the second machine-learning model to one or more devices; (b) receive a trained version of a decoder for the second machine-learning model from one or more devices; and (c) update the decoder of the second machine-learning model based on the trained version of the decoder received from one or more device. The processing circuitry is configured to update a decoder of the first machine-learning model based on the updated decoder of the second machine-learning model.

### FIELD

The present disclosure relates to federated learning. In particular, examples of the present disclosure relate to an apparatus and methods for federated learning of a first machine-learning model, a device and a method for a device.

### BACKGROUND

Deep learning models that are deployed to edge devices for diverse customer use cases (e.g., convenience store analysis or traffic monitoring) are typically created by training on customer data, which often lacks the necessary labels. To overcome this, foundation models may be employed in the cloud to automatically label the customer data before using it for training. The foundation model is a deep learning model that is trained on broad data such that it can be applied across a wide range of use cases

However, several challenges exist in this process. From the perspective of the foundation model, relying on a single model to handle all scenarios is impractical as it cannot adequately cater to the vast array of specific use cases. Additionally, developing new models for each unique use case is both costly and resource-intensive, making this approach inefficient.

From the perspective of customer data, another significant challenge is the scarcity of production data. Customers often struggle to provide enough data for training because the data collection process is complex and costly. Furthermore, collecting data manually presents potential privacy concerns, especially if the data contain images related to humans.

Hence, there may be a demand for improved learning of machine-learning models.

### SUMMARY

This demand is met by an apparatus and methods for federated learning of a first machine-learning model, a device and a method for a device in accordance with the independent claims. Further embodiments are defined by the dependent claims.

According to a first aspect, the present disclosure provides an apparatus for federated learning of a first machine-learning model. The apparatus includes processing circuitry configured to generate a second machine-learning model from the first machine-learning model. The second machine-learning model is smaller than the first machine-learning model. The second machine-learning model includes a backbone and a decoder. The processing circuitry is further configured to perform at least one iteration of the following (a) to (c): (a) output the decoder of the second machine-learning model to one or more devices and for the first iteration of the at least one iteration further output the backbone of the second machine-learning model to the one or more devices; (b) receive a trained version of a decoder for the second machine-learning model from the one or more devices; and (c) update the decoder of the second machine-learning model based on the trained version of the decoder received from the one or more devices. In addition, the processing circuitry is configured to update a decoder of the first machine-learning model based on the updated decoder of the second machine-learning model.

According to a second aspect, the present disclosure provides a server or a computing cloud comprising the apparatus according to the first aspect.

According to a third aspect, the present disclosure provides a device comprising processing circuitry configured to perform at least one iteration of the following: receive a decoder of a machine-learning model from a server or computing cloud; train the received decoder of the machine-learning model using local data at the device; and output the trained decoder for the machine-learning model to the server or computing cloud. A backbone of the machine-learning model is further received in the first iteration of the at least one iteration. The received decoder is an updated version of the received decoder compared to a previous iteration for the second and each further iteration of the at least one iteration.

According to a fourth aspect, the present disclosure provides a method for federated learning of a first machine-learning model. The method comprises generating a second machine-learning model from the first machine-learning model. The second machine-learning model is smaller than the first machine-learning model. The second machine-learning model comprises a backbone and a decoder. The method further comprises performing at least one iteration of the following (a) to (c): (a) outputting the decoder of the second machine-learning model to one or more devices and for the first iteration of the at least one iteration further outputting the backbone of the second machine-learning model to the one or more devices; (b) receiving a trained version of a decoder for the second machine-learning model from the one or more devices; and (c) updating the decoder of the second machine-learning model based on the trained version of the decoder received from the one or more devices. In addition, the method comprises updating a decoder of the first machine-learning model based on the updated decoder of the second machine-learning model.

According to a fifth aspect, the present disclosure provides a method for a device. The method comprises performing at least one iteration of the following: receiving a decoder of a machine-learning model from a server or computing cloud; training the received decoder of the machine-learning model using local data at the device; and outputting the trained decoder for the machine-learning model to the server or computing cloud. A backbone of the machine-learning model is further received in the first iteration of the at least one iteration. The received decoder is updated version of the received decoder compared to a previous iteration for the second and each further iteration of the at least one iteration.

According to a sixth aspect, the present disclosure provides another method for federated learning of a first machine-learning model. The method comprises generating, at a server or computing cloud, a second machine-learning model from the first machine-learning model. The second machine-learning model is smaller than the first machine-learning model. The second machine-learning model comprises a backbone and a decoder. The method further comprises performing at least one iteration of the following: outputting, by the server or computing cloud, the decoder of the second machine-learning model to a one or more devices and for the first iteration of the at least one iteration further outputting the backbone of the second machine-learning model to the one or more devices; training the respective received decoder of the second machine-learning model locally at the one or more devices using local data at the respective device; outputting, by the one or more devices, the respective trained decoder for the second machine-learning model to the server or computing cloud; and updating, by the server or computing cloud, the decoder of the second machine-learning model based on the trained decoders received from the one or more devices. In addition, the method comprises updating, by the server or computing cloud, a decoder of the first machine-learning model based on the updated decoder of the second machine-learning model.

According to a seventh aspect, the present disclosure provides a use of the first machine-learning model obtained by one of the methods according to any one of the fourth aspect and the sixth aspect for processing image data.

According to an eighth aspect, the present disclosure provides a method for processing image data which comprises using the first machine-learning model obtained by one of the methods according to the fourth aspect and the sixth aspect.

According to a nineth aspect, the present disclosure provides a non-transitory machine-readable medium having stored thereon a program having a program code for performing the method according to any one of the fourth to sixth aspects, when the program is executed on a processor or a programmable hardware.

According to a tenth aspect, the present disclosure provides a program having a program code for performing the method according to any one of the fourth to sixth aspects, when the program is executed on a processor or a programmable hardware.

### BRIEF DESCRIPTION OF THE FIGURES

Some examples of apparatuses and/or methods will be described in the following by way of example only, and with reference to the accompanying figures, in which

FIG. 1 illustrates an example of a system for federated learning;

FIG. 2 illustrates an exemplary process flow for federated learning;

FIG. 3 illustrates a flowchart of an example of a method for federated learning of a first machine-learning model;

FIG. 4 illustrates a flowchart of an example of a method for a device; and

FIG. 5 illustrates a flowchart of another example of a method for federated learning of a first machine-learning model.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

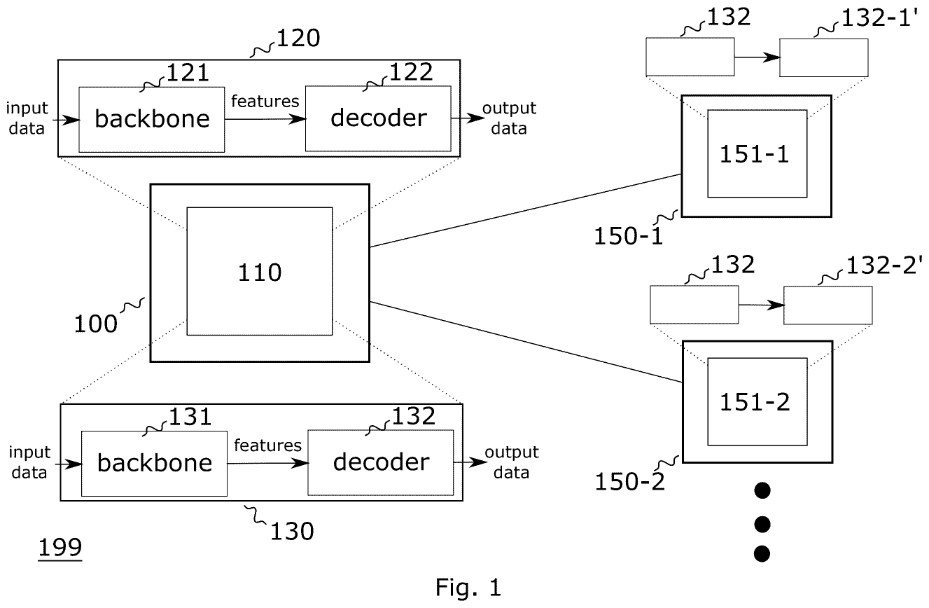

FIG. 1 illustrates a system 199 for federated learning of a first machine-learning model 120.

In general, a machine-learning model such as the first machine-learning model 120 is a data structure and/or set of rules representing a statistical model that circuitry uses to perform a specific task without using explicit instructions, instead relying on patterns and inference. The data structure and/or set of rules represents learned knowledge (e.g. based on training performed by a machine-learning algorithm as described below). In machine-learning, instead of a rule-based transformation of data, a transformation of data may be used, that is inferred from an analysis of training data.

The first machine-learning model 120 comprises a backbone 121 and a decoder 122. The backbone 121 is a part of the first machine-learning model 120 that is configured to extract features from input data. Features are individual measurable properties or characteristics of the input data that are used by the first machine-learning model 120 to generate (produce) outputs, predictions or decisions. The backbone 121 is configured to take (receive) input data such as image data, audio data, sensor data or text data and process it through one or more layers (e.g., multiple layers) to extract high level, abstract features that are relevant for a specific task such as, e.g., image classification, object detection, object tracking, event detection or language modeling. The output of the backbone 121 is a feature representation, which is a condensed, high-dimensional summary of the input data. These features capture (e.g., important or prioritized) aspects of the input data that are relevant to the task at hand. The decoder 122 is configured to take (receive) the features generated by the backbone 121 and generate (produce) outputs or predictions, i.e., output data, of the first machine-learning model 120 based on the features. In other words, the decoder 122 is configured to convert the features output by the backbone 121 into a target (desired) output format. For example, in image processing, the backbone 121 may receive an image as input data and detect features such as edges, textures, shapes, and objects. Then, the decoder 122 may take the features extracted from the backbone 121 and map them to a set of class labels or produce bounding box coordinates (the bounding box is not necessarily rectangular) and class labels for objects within the image.

The first machine-learning model 120 may, e.g., be an Artificial Neural Network (ANN) such as a Convolutional Neural Network (CNN). In these examples, the backbone 121 may comprise one or more (e.g., multiple) convolutional layers of the CNN. In other examples, the first machine-learning model 120 may, e.g., be a transformer based machine-learning model (a transformer model). In these examples, the backbone 121 may comprise one or more (e.g., multiple) transformer layers of the transformer based machine-learning model. Similarly, the decoder 122 may comprise one or more layers of the CNN or the transformer based machine-learning model that gradually upsample, transform, or interpret the features (feature representation) to produce the output data of the first machine-learning model 120. However, it is to be noted that the present disclosure is not limited to CNNs and transformer models. The first machine-learning model 120 may alternatively comprise a different structure and, e.g., be an autoencoder, a Generative Adversarial Network (GAN), a Recurrent Neural Network (RNN), a Variational Autoencoder (VAE) or a Capsule Network (CapsNet) with backbone-decoder structure.

The system 199 comprises an apparatus 100 for federated learning of the first machine-learning model 120. Additionally, the system 199 comprise one or more devices 150-1, 150-2, . . . communicatively coupled to the apparatus 100 via a communication network such as the Internet. According to examples, the system 199 may comprise a plurality (i.e., N≥2) of the devices 150-1, 150-2, . . . . For reasons of simplicity, two devices 150-1 and 150-2 are illustrated in FIG. 1. The one or more devices 150-1, 150-2, . . . are devices (logically and locally) separate from the apparatus 100. For example, a server or a computing cloud may comprise or be the apparatus 100, and the one or more devices 150-1, 150-2, . . . may be edge devices. Compared to a centralized network element like the apparatus 100, server or computing cloud, an edge device is a local device processing data at the periphery (“edge”) of a network. For example, the edge device may process data to make decisions using machine-learning models at the source or at least nearer the source of where data is input or captured.

The apparatus 100 comprises processing circuitry 110. For example, the processing circuitry 110 may be a single dedicated processor, a single shared processor, or a plurality of individual processors, some of which or all of which may be shared, a Digital Signal Processor (DSP) hardware, an Application Specific Integrated Circuit (ASIC), a System-on-a-Chip (SoC) a neuromorphic processor or a Field Programmable Gate Array (FPGA). The processing circuitry 110 may optionally be coupled to, e.g., memory such as Read Only Memory (ROM) for storing software, Random Access Memory (RAM) and/or non-volatile memory. For example, the apparatus 100 may comprise memory configured to store instructions, which when executed by the processing circuitry 110, cause the processing circuitry 110 to perform the steps and methods described herein.

The processing circuitry 110 is configured to generate (derive) a second machine-learning model 130 from the first machine-learning model 120. Like the first machine-learning model 120, the second machine-learning model 130 comprises a backbone-decoder structure. In other words, the second machine-learning model 130 comprises a backbone 131 and a decoder 132. The second machine-learning model 130 is smaller than the first machine-learning model 120. The term “smaller” denotes that the second machine-learning model 130 is smaller (reduced, lighter) with respect to at least one of complexity, size and resource requirements compared to the first machine-learning model 120. For example, the second machine-learning model 130 may be less complex (e.g., comprise fewer parameters representing weights and biases within the model), comprise fewer layers or neurons, require less memory to store its parameters and less disk space to save the model, have faster inference speed (times), have lower latency times, take less time and computational power to train, or combinations thereof compared to the first machine-learning model 120.

The second machine-learning model 130 may be generated from the first machine-learning model 120 by the processing circuitry 110 in various ways.

For example, the processing circuitry 110 may be configured to generate the second machine-learning model 130 from the first machine-learning model 120 using knowledge distillation. Knowledge distillation is the process of transferring knowledge from a large machine-learning model to a smaller one. Accordingly, the knowledge of the first machine-learning model 120 is transferred to the second machine-learning model 130 by knowledge distillation. The first machine-learning model 120 is the “teacher” model and the second machine-learning model 130 is the “student” model. During knowledge distillation, the student model is trained to mimic the output of the teacher model. This process involves using the outputs or predictions (called “soft labels”) of the teacher model as targets for the student model, rather than using the original training data labels directly. For example, the processing circuitry 110 may be configured to generate the second machine-learning model 130 from the first machine-learning model 120 using knowledge distillation by training the backbone 131 of the second machine-learning model 130 to minimize a loss function (knowledge distillation loss function) that measures the difference between output data (features) of the backbone 131 of the second machine-learning model 130 and output data (features) of the backbone 121 of the first machine-learning model 120 for the same input data. Further, the processing circuitry 110 may be configured to keep the first machine-learning model 120 unchanged (i.e., not alter, train or adapt) when generating the second machine-learning model 130. For example, the same set of images may be input to both the backbone 121 of the first machine-learning model 120 and the backbone 131 of the second machine-learning model 130. The output features are aligned with the knowledge distillation loss function. If the model parameters of the first machine-learning model 120 are frozen (i.e., not trained and kept unchanged) during the knowledge distillation process, only model parameters of the smaller second machine-learning model 130 are trained via, e.g., backpropagation of the loss function, such that the features output by the smaller second machine-learning model 130's backbone 131 are aligned with (e.g., consistent with, similar to, close to, not conflicting with) the features output by backbone 121 of the first machine-learning model 120.

Knowledge distillation enables efficient model compression while maintaining high accuracy, improving training efficiency, ensuring adaptability to different environments, enhancing data privacy, and supporting scalability in federated learning settings. By training the backbone 131 of the second (smaller) machine-learning model 130 to match the output of the backbone 121 of the first (larger) machine-learning model 120, the second machine-learning model 130 is effectively learning to replicate the feature extraction capabilities of the first machine-learning model 120. This means that the second machine-learning model 130 may generate high-quality features from the input data that are similar to those produced by the first machine-learning model 120. By ensuring that the smaller second machine-learning model 130 closely approximates the performance of the larger first machine-learning model 120 in this critical area, the second machine-learning model 130 may achieve high performance despite its reduced size and complexity. This alignment ensures that the smaller second machine-learning model 130 retains the most important and relevant feature representations, which are crucial for maintaining performance on downstream decoder tasks such as classification, detection, or segmentation. Keeping the first machine-learning model 120 unchanged during the generation of the second machine-learning model 130 ensures operational continuity, minimizes risk, simplifies the model generation process, and enables parallel development and testing.

Alternatively, the second machine-learning model 130 may be generated from the first machine-learning model 120 by the processing circuitry 110 using other techniques such as pruning (i.e., removing parts of a first machine-learning model 120 that are deemed unnecessary or less important for making accurate outputs), quantization (i.e., reducing the precision of the first machine-learning model 120's parameters), low-rank factorization (i.e., decomposing the weight matrices of the first machine-learning model 120 into lower-rank matrices to reduce the number of parameters) or neural architecture search (i.e., searching for an optimal architecture that is smaller or more efficient than the first machine-learning model 120 while retaining comparable performance). However, the present disclosure is not limited to the aforementioned techniques for generating a smaller machine-learning model from a larger machine-learning model. Other suitable techniques may be used as well.

After generating the second machine-learning model 130, at least one iteration of the processing described in the following is performed by the system 199.

The processing circuitry 110 is configured to output (transmit) the decoder 132 of the second machine-learning model 130 to the one or more devices 150-1, 150-2, . . . (e.g., to a plurality of the devices 150-1, 150-2, . . . ) in each of the at least one iteration. In the first iteration of the at least one iteration, the processing circuitry 110 is further configured to output the backbone 131 of the second machine-learning model 130 to the one or more devices 150-1, 150-2, . . . (e.g., to a plurality of the devices 150-1, 150-2, . . . ). The backbone 131 and the decoder 132 of the second machine-learning model 130 may be output together or separately in the first iteration of the at least one iteration by the processing circuitry 110. According to examples, the backbone 131 of the second machine-learning model 130 is not output to the one or more devices 150-1, 150-2, . . . in the second and each further iteration.

Accordingly, respective processing circuitry 151-1, 151-2, . . . of the one or more devices 150-1, 150-2, . . . (e.g., of a plurality of the devices 150-1, 150-2, . . . ) is configured to receive the decoder 132 of the second machine-learning model 130 from the processing circuitry 110 of the apparatus 100 in each of the at least one iteration. In the first iteration of the at least one iteration, the respective processing circuitry 151-1, 151-2, . . . is configured to further receive the backbone 131 from the processing circuitry 110 of the apparatus 100. The respective processing circuitry 151-1, 151-2, . . . of the one or more devices 150-1, 150-2, . . . may be implemented analogously to what is described above for the processing circuitry 110 of the apparatus 100. In addition to the respective processing circuitry 151-1, 151-2, . . . , the one or more devices 150-1, 150-2, . . . may each comprise further circuitry such as one or more sensors, one or more cameras (imagers), memory, etc.

The respective processing circuitry 151-1, 151-2, . . . of the one or more devices 150-1, 150-2, . . . (e.g., of a plurality of the devices 150-1, 150-2, . . . ) is configured to train the respective received decoder 132 of the second machine-learning model 130 locally at the one or more devices 150-1, 150-2, . . . using local data at the respective device 150-1, 150-2, . . . in each of the at least one iteration. That is, the processing circuitry 151-1 is configured to train the received decoder 132 of the second machine-learning model 130 locally at the device 150-1 using local data at the device 150-1 in each of the at least one iteration, the processing circuitry 151-2 is configured to train the received decoder 132 of the second machine-learning model 130 locally at the device 150-2 using local data at the device 150-2 in each of the at least one iteration, and so on. In other words, the processing circuitry 110 is configured to output the decoder 132 of the second machine-learning model 130 to the one or more devices 150-1, 150-2, . . . (e.g., to a plurality of the devices 150-1, 150-2, . . . ) in each of the at least one iteration for training the decoder 132 of the second machine-learning model 130 locally at the one or more devices 150-1, 150-2, . . . (e.g., at a plurality of the devices 150-1, 150-2, . . . ) using local data at the respective device 150-1, 150-2, . . . . Accordingly, a respective trained decoder 132-1′, 132-2′, . . . for the second machine-learning model 130 is obtained at each of the one or more devices 150-1, 150-2, . . . in each of the at least one iteration.

The local data at the respective device 150-1, 150-2, . . . is data that is stored and available on each individual device. This data is local in the sense that it resides on the device 150-1, 150-2, . . . itself and is not transferred or centralized to the apparatus 100 for training purposes. For example, the local data may be generated, collected, or stored locally on the respective device 150-1, 150-2, . . . and reflect the specific environment, user interactions, or context in which the device operates. The local data may include any form of data relevant to the task the first machine-learning model 120 is being trained on, such as images, text, audio, sensor data, usage patterns, or other types of data unique to the device's user or context.

The received decoder 132 is trained by a machine-learning algorithm at the respective device 150-1, 150-2, . . . . The term “machine-learning algorithm” denotes a set of instructions that are used to train a machine-learning model or a part thereof such as the received decoder 132. By training the received decoder 132 using the local data at the respective device 150-1, 150-2, . . . , the decoder 132 “learns” a transformation between a part of the local data used as input training data and another part of the local data used as desired (target) output for the input training data, which may be used to provide an output based on non-training data provided to the decoder 132.

For example, the decoder 132 may be trained locally using a training method called “supervised learning”. In supervised learning, the decoder 132 is trained using a plurality of training samples, wherein each sample may comprise a plurality of input data values (e.g., features), and a plurality of desired output values (e.g., predictions or labels), i.e., each training sample is associated with a desired output value. By specifying both training samples and desired output values, the decoder 132 “learns” which output value to provide based on an input sample that is similar to the samples provided during the training.

Apart from supervised learning, semi-supervised learning may be used. In semi-supervised learning, some of the training samples lack a corresponding desired output value. Semisupervised learning may be based on a semi-supervised learning algorithm (e.g. a classification algorithm or a similarity learning algorithm). Classification algorithms may be used as the desired outputs of the trained decoder 132-1′, 132-2′, . . . are restricted to a limited set of values (categorical variables), i.e., the input is classified to one of the limited set of values. Similarity learning algorithms are similar to classification algorithms but are based on learning from examples using a similarity function that measures how similar or related two objects are.

Apart from supervised or semi-supervised learning, unsupervised learning may be used to train the decoder 132. In unsupervised learning, (only) input data are supplied and an unsupervised learning algorithm is used to find structure in the input data (e.g., by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the decoder 132. In reinforcement learning, one or more software actors (called “software agents”) are trained to take actions in an environment. Based on the taken actions, a reward is calculated. Reinforcement learning is based on training the one or more software agents to choose the actions such that the cumulative reward is increased, leading to software agents that become better at the task they are given (as evidenced by increasing rewards).

Furthermore, additional techniques may be applied to some of the machine-learning algorithms. For example, feature learning may be used. In other words, the decoder 132 may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

It is to be noted that the present disclosure is not limited to the aforementioned training techniques. Other suitable training techniques may be used instead or in addition.

Since the local data used for training the decoder 132 of the second machine-learning model 130 remains on the respective device 150-1, 150-2, . . . and is not transferred to the apparatus 100 (or a central server or computing cloud comprising or being the apparatus 100), data privacy may be significantly enhanced. This is particularly beneficial in applications involving sensitive personal information. For example, sensitive personal information may be image data, health care data, financial data or various classification which may allow a person or group to be discriminated against whether intentionally or implicitly. Furthermore, applications involving commercially sensitive data such as data related to customers, ways of operating, sales and profit data, unpublished data, pre-public launch data, research and development data may benefit from keeping the local data on the respective device 150-1, 150-2, . . . . The one or more devices 150-1, 150-2, . . . adapt the decoder 132 to their local data. This localized learning ensures that the decoder 132 is better tailored to specific environments or user needs.

The respective processing circuitry 151-1, 151-2, . . . may be configured to train only the received decoder 132 of the second machine-learning model 130 using the local data at the respective device 151-1, 151-2, . . . while keeping the received backbone 131 of the second machine-learning model 130 unchanged (i.e., not alter, train or adapt) in each of the at least one iteration. For example, the processing circuitry 110 of the apparatus 100 may be configured to control the one or more devices 150-1, 150-2, . . . (e.g., a plurality of the devices 150-1, 150-2, . . . ) to train only the received decoder 132 of the second machine-learning model 130 locally at the one or more devices 150-1, 150-2, . . . (e.g., a plurality of the devices 150-1, 150-2, . . . ) using local data at the respective device 150-1, 150-2, . . . while keeping the received backbone 131 of the second machine-learning model 130 unchanged in each of the at least one iteration.

By focusing only on training the received decoder 132 and keeping the received backbone 131 unchanged, the computational complexity of the local training is reduced. This is particularly beneficial if one or more of the devices 151-1, 151-2, . . . exhibits only limited processing power and memory (e.g., if one or more of the devices 151-1, 151-2, . . . is/are mobile phone(s), tablet-computer(s), wearable(s) or IoT device(s)). Training only the decoder 132 allows for faster training iterations. This may be beneficial for battery-operated devices as the power consumption is reduced, resulting in higher efficiency, better user experiences and longer device lifespans. Keeping the received backbone 131 unchanged ensures that the feature extraction process remains consistent across different ones of the one or more of the devices 151-1, 151-2, . . . . Consistent feature extraction may be beneficial for ensuring that the knowledge learned at different ones of the one or more of the devices 151-1, 151-2, . . . may be effectively aggregated at the apparatus 100. This uniformity enhances the robustness and accuracy of the federated learning process.

The respective processing circuitry 151-1, 151-2, . . . of the one or more devices 150-1, 150-2, . . . (e.g., of a plurality of the devices 150-1, 150-2, . . . ) is configured to output (transmit) the respective trained decoder 132-1′, 132-2′, . . . for the second machine-learning model 130 to the apparatus 100 (or a server or computing cloud comprising or being the apparatus 100) in each of the at least one iteration. For example, the respective processing circuitry 151-1, 151-2, . . . of the one or more devices 150-1, 150-2, . . . (e.g., of a plurality of the devices 150-1, 150-2, . . . ) may be configured to output only the respective trained decoder 132-1′, 132-2′, . . . for the second machine-learning model 130 to the apparatus 100 (or a server or computing cloud comprising or being the apparatus 100) in each of the at least one iteration. By outputting only the respective trained decoder 132-1′, 132-2′, . . . (rather than the entire trained second machine-learning model 130 further comprising the backbone 131), the amount of data transmitted is reduced. This is particularly advantageous in scenarios with limited network bandwidth or high communication costs. Limiting the data transfer to just the respective trained decoder 132-1′, 132-2′, . . . minimizes the risk of exposing sensitive information in the respective local data, even indirectly. It prevents any potentially identifiable information from being inadvertently included in the data sent back to the apparatus 100 (or a server or computing cloud comprising or being the apparatus 100).

Accordingly, the processing circuitry 110 of the apparatus 100 is configured receive a (respective) trained version of a decoder for the second machine-learning model 130 from the one or more devices 150-1, 150-2, . . . in each of the at least one iteration. For example, the processing circuitry 110 may be configured to receive the respective trained decoder 132-1′, 132-2′, . . . for the second machine-learning model 130 from the one or more devices 150-1, 150-2, . . . in each of the at least one iteration.

The processing circuitry 110 is further configured to update the decoder 132 of the second machine-learning model 130 based on the trained version of the decoder received from the one or more devices 150-1, 150-2, . . . in each of the at least one iteration. For example, the processing circuitry 110 may be configured to update the decoder 132 of the second machine-learning model 130 based on the respective trained decoder 132-1′, 132-2′, . . . received from the one or more devices 150-1, 150-2, . . . in each of the at least one iteration. In other words, the processing circuitry 110 iteratively improves the decoder 132 of the smaller, second machine-learning model 130 based on training conducted on one or more devices 150-1, 150-2, . . . . Accordingly, the decoder 132 of the second machine-learning model 130 may be collaboratively trained across multiple devices 150-1, 150-2, . . . while keeping the (training) data localized to each device 150-1, 150-2, . . . . In case the system 199 comprises/uses only one of the one or more devices 150-1, 150-2, . . . , updating the decoder 132 of the second machine-learning model 130 may comprise or be replacing the decoder 132 with the trained version of the decoder received from the one device. In case the system 199 comprises/uses multiple devices 150-1, 150-2, . . . , the trained decoders 132-1′, 132-2′, . . . received from the devices 150-1, 150-2, . . . may be aggregated. Aggregation may be done in various ways, such as averaging (the model weights of) the received trained decoders 132-1′, 132-2′, . . . or using more sophisticated techniques like weighted averaging (where each device's trained decoder 132-1′, 132-2′, . . . is weighted by, e.g., the amount or quality of its local data), gradient aggregation or other federated optimization algorithms. The aggregation results in an updated version of the decoder 132 for the second machine-learning model 130. This updated decoder incorporates knowledge learned from the diverse datasets present on the different devices 150-1, 150-2, . . . .

The processing circuitry 110 may be configured to update only the decoder 132 of the second machine-learning model 130 while keeping the backbone 131 of the second machine-learning model 130 unchanged (i.e., not alter, train or adapt) in each of the at least one iteration. By keeping the backbone 131 unchanged, uniformity to the backbone 121 of the first machine-learning model may be ensured.

The updated decoder of the second machine-learning model 130 is then distributed to the one or more devices 150-1, 150-2, . . . for the second and each further iteration of the at least one iteration for further training. In other words, the decoder received by the one or more devices 150-1, 150-2, . . . . for the second and each further iteration of the at least one iteration is an updated version of the received decoder compared to a previous iteration. This updated decoder is different from the one received in the previous iteration, as it has been improved using the new insights gained from the last round of training.

The processing circuitry 110 as well as the respective processing circuitry 151-1, 151-2, . . . of the one or more devices 150-1, 150-2, . . . may be configured to iteratively perform the above until a) the second machine-learning model 130 with the updated decoder or b) the updated decoder of the second machine-learning model 130 satisfies a predefined criterion. This iterative processing allows to continually improve the performance of the second machine-learning model 130 by gradually refining its decoder 131 using training updates from the one or more devices 150-1, 150-2, . . . . The predefined criterion is a specific goal or condition set in advance that determines when the iterative process of updating the decoder 131 of the second machine-learning model 130 should stop. This criterion serves as a stopping rule for the training process to ensure that the decoder 131 of the second machine-learning model 130 has achieved the desired level of performance or has met a specific objective. The predefined criterion may, e.g., be a set of one or more predetermined conditions or thresholds that must be satisfied to conclude the iterative process of training or updating the decoder 131 of the second machine-learning model 130. These conditions may be based on various metrics related to the second machine-learning model 130′s performance, resource usage, or other relevant factors and are used to determine when further iterations are no longer necessary or beneficial. For example, the predefined criterion may be that the second machine-learning model 130 or its decoder 131 has converged (i.e., that further updated of the decoder 131 do not significantly change the performance of the second machine-learning model 130 or the decoder 131). Alternatively or additionally, the predefined criterion may be that the second machine-learning model 130 or its decoder 131 achieves a predefined accuracy threshold (e.g., on a validation data), indicating that it is sufficiently trained. Further alternatively or additionally, the predefined criterion may be that a predefined maximum number of iterations is achieved. This may allow to avoid indefinite training and ensure timely deployment. The predefined criterion ensures that the iterative process is efficient and stops when the desired performance is achieved.

The processing circuitry 110 is configured to update the decoder 122 of the first machine-learning model 120 based on the updated decoder of the second machine-learning model 130 (e.g., the updated decoder of the second machine-learning model 130 obtained in the last iteration of the at least one iteration). By updating the decoder 122 of the first machine-learning model 120 based on the updated decoder of the second machine-learning model 130, the improvements made to the decoder of the smaller, second machine-learning model 130 are transferred back to the original, larger first machine-learning model 120. Accordingly, the larger first machine-learning model 120 benefits from the insights and knowledge gathered during the above described federated learning process.

The decoder 122 of the first machine-learning model 120 may be updated in various ways. For example, the processing circuitry 110 may be configured to update the decoder 122 of the first machine-learning model 120 by replacing the decoder 122 of the first machine-learning model 120 with the updated decoder of the second machine-learning model 130. In other words, the updated decoder of the second machine-learning model 130 may directly replace the existing decoder 122 of the first machine-learning model 120. For example, a direct plug-in mechanism may be used to replace the decoder 122 of the first machine-learning model 120 with the updated decoder of the second machine-learning model 130. Simply plugging the updated decoder of the second machine-learning model 130 back into the first machine-learning model 120 is possible because the second machine-learning model 130 is derived from the first machine-learning model 120 (e.g., by knowledge distillation). This alignment ensures that the smaller second machine-learning model 130 has similar features as the first machine-learning model 120, such that the decoder trained with the frozen smaller second machine-learning model 130 may be effectively integrated and utilized by the first machine-learning model 120. In alternative examples, the processing circuitry 110 may be configured to update the decoder 122 of the first machine-learning model 120 by integrating parameters of the updated decoder of the second machine-learning model 130 into the decoder 122 of the first machine-learning model 120 by fine-tuning. For example, weights and biases of the first machine-learning model 120's decoder 122 may be adjusted or updated based on the parameters of the updated decoder of the second machine-learning model 130. This may ensure a smooth transition and adaptation of the improvements.

According to examples of the present disclosure, the processing circuitry 110 may be configured to update only the decoder 122 of the first machine-learning model 120 while keeping the backbone 121 of the first machine-learning model 120 unchanged (i.e., not alter, train or adapt). In other words, the backbone 121 is left intact, and only the parameters of the decoder 122 are updated based on the knowledge acquired through the federated learning process. Updating only the decoder 122 (rather than the entire first machine-learning model 120) is a focused and efficient way to transfer improvements. Since the decoder 122 is responsible for the final decision-making or output generation, refining it directly impacts the first machine-learning model 120's performance on the target tasks.

The first machine-learning 120 may, e.g., be a foundation model. A foundation model in machine-learning is a large-scale, pre-trained model that serves as a general-purpose building block for a wide range of downstream tasks. The foundation model is trained on vast amounts of diverse data and may be efficiently adapted or fine-tuned for specific tasks with the above processing. For example, if the foundation model is for general English voice recognition, it may not perform optimally in specific environments such as cars or noisy streets. The proposed learning of the foundation model allows to train a decoder for these specific contexts while preserving privacy. The proposed technology allows for domain adaptation, making it suitable for tailoring machine-learning models to specialized applications that differ significantly from the general use cases covered by the foundation model.

The proposed learning of the first machine-learning model 120 introduces a streamlined end-to-end workflow, including various techniques such as knowledge distillation, federated learning of decoders, and reintegration into the first machine-learning model 120 (e.g., a foundation model). This cohesive process efficiently enhances model performance across various use cases. The proposed concept uses federated learning to train decoders on (e., edge) devices, allowing them to learn from local data and improve the first machine-learning model 120 (e.g., a foundation model in the cloud). This plug-in mechanism ensures continuous model improvement while preserving data privacy. By aligning the features of the first machine-learning model 120 (e.g., a foundation model) with the smaller second machine-learning model 130 (e.g., through knowledge distillation), the smaller second machine-learning model 130 becomes suitable for federated learning. This ensures that the smaller second machine-learning model 130 retains critical performance characteristics while being feasible for edge deployment.

By using the smaller second machine-learning model 130 for federated learning, the computational and memory constraints of the (e.g., edge) devices 150-1, 150-2, . . . are addressed, making the training process more feasible. Furthermore, it is ensured that raw data remains on the (e.g., edge) devices 150-1, 150-2, . . . , mitigating privacy concerns associated with data transfer to central devices such as the apparatus 100 or one or more servers comprising the apparatus. The proposed learning of the first machine-learning model 120 allows for the continuous improvement of the first machine-learning model 120 (e.g., a foundation model) without the need to manage numerous large models in the cloud, simplifying the process as use cases proliferate. The proposed technology reduces the cost associated with developing and maintaining multiple foundation models by focusing on the training of smaller, more manageable machine-learning models.

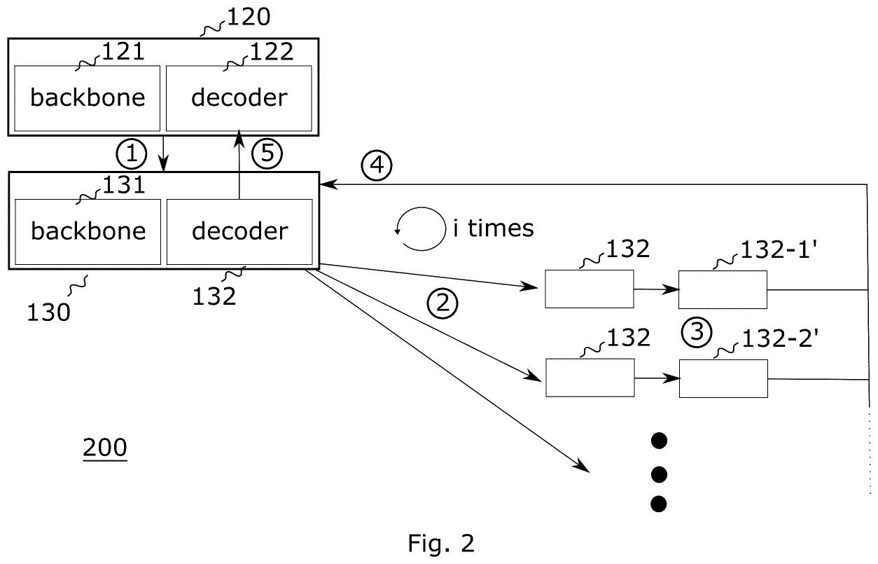

For further highlighting the above described federated learning, FIG. 2 illustrates an exemplary data flow 200.

First, the second machine-learning model 130 is generated from the first machine-learning model 120 (e.g., at a server or computing cloud comprising the apparatus 100). For example, knowledge distillation may be used to generate the second machine-learning model 130 from the first machine-learning model 120. The first machine-learning model 120 and the second machine-learning model 130 each comprise a backbone 121, 131 and a decoder 122, 132. As described above, the second machine-learning model 130 is smaller than the first machine-learning model 120.

Then, the knowledge of data at one or more devices such as edge devices is learned and absorbed via federated learning of the second machine-learning model 130's decoder 132. The model parameters of the second machine-learning model 130's backbone 131 are frozen. This includes sending or transmitting the decoder 132 to the devices. Each device conducts local training of the decoder 132 on its local data with the backbone 131 frozen and only training the decoder 132. After training, each device uploads or sends back the model updates 132-1′, 132-2′, . . . of the decoder 132 to the apparatus 100 (or a server or computing clod comprising the apparatus 100).

The received model updates 132-1′, 132-2′, . . . of the decoder 132 are aggregated (e.g., via weighted averaging or other more advanced model aggregation algorithms) to create an updated version of the decoder 132. The updated version of the decoder 132 is sent to the devices for the next round of training. The above described steps for federated learning (denoted by reference signs 2 to 4 in FIG. 2) are performed iteratively for i times (i being an integer≥1), for instance until the second machine-learning model 130 with the updated version of the decoder 132 reaches convergence.

Then the decoder 122 of the first machine-learning model 120 is updated based on the updated version of decoder 132 of the second machine-learning model 130. For example, the on the updated version of decoder 132 of the second machine-learning model 130 may be directly plugged into the first machine-learning model 120 due to the knowledge distillation alignment of the first machine-learning model 120 and the second machine-learning model 130

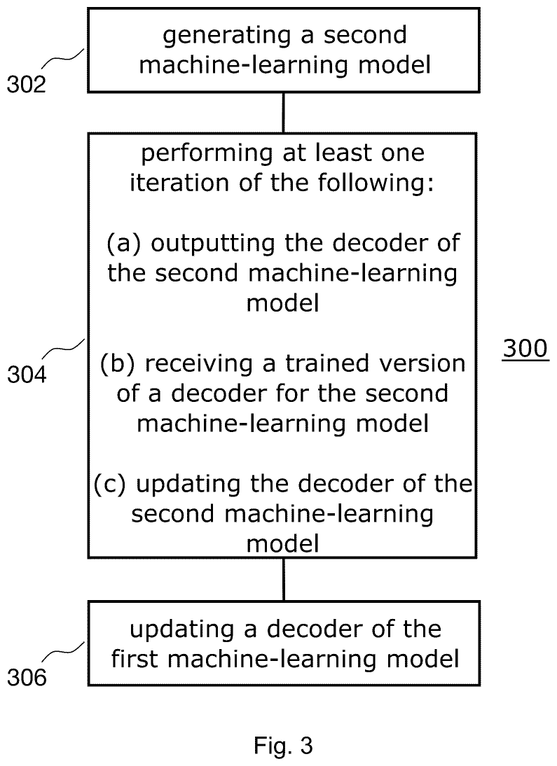

For further highlighting the aspects of federated learning performed by/at the server or computing cloud described above, FIG. 3 illustrates a flowchart of a method 300 for federated learning of a first machine-learning model. The method 300 comprises generating 302 a second machine-learning model from the first machine-learning model. The second machine-learning model is smaller than the first machine-learning model. The second machine-learning model comprises a backbone and a decoder. The method 300 further comprises performing 304 at least one iteration of the following (a) to (c): (a) outputting the decoder of the second machine-learning model to one or more devices and for the first iteration of the at least one iteration further outputting the backbone of the second machine-learning model to the one or more devices; (b) receiving a trained version of a decoder for the second machine-learning model from the one or more devices; and (c) updating the decoder of the second machine-learning model based on the trained version of the decoder received from the one or more devices. In addition, the method 300 comprises updating 306 a decoder of the first machine-learning model based on the updated decoder of the second machine-learning model.

Analogously to what is described above, the method 300 provides improved federated learning.

More details and aspects of the method 300 are explained in connection with the proposed technique or one or more examples described above (e.g., FIG. 1 and FIG. 2). The method 300 may comprise one or more additional optional features corresponding to one or more aspects of the proposed technique or one or more examples described above.

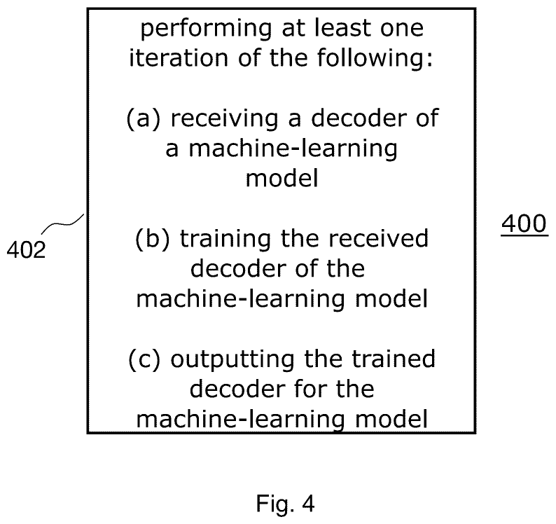

For further highlighting the aspects of federated learning performed by/at the (e.g., edge) devices described above, FIG. 4 illustrates a flowchart of a method 400 for a device (e.g., an edge device). The method 400 comprises performing 402 at least one iteration of the following: (a) receiving a decoder of a machine-learning model from a server or computing cloud; (b) training the received decoder of the machine-learning model using local data at the device; and (c) outputting the trained decoder for the machine-learning model to the server or computing cloud. A backbone of the machine-learning model is further received in the first iteration of the at least one iteration. The received decoder is updated version of the received decoder compared to a previous iteration for the second and each further iteration of the at least one iteration.

Analogously to what is described above, the method 400 enables improved federated learning.

More details and aspects of the method 400 are explained in connection with the proposed technique or one or more examples described above (e.g., FIG. 1 and FIG. 2). The method 400 may comprise one or more additional optional features corresponding to one or more aspects of the proposed technique or one or more examples described above.

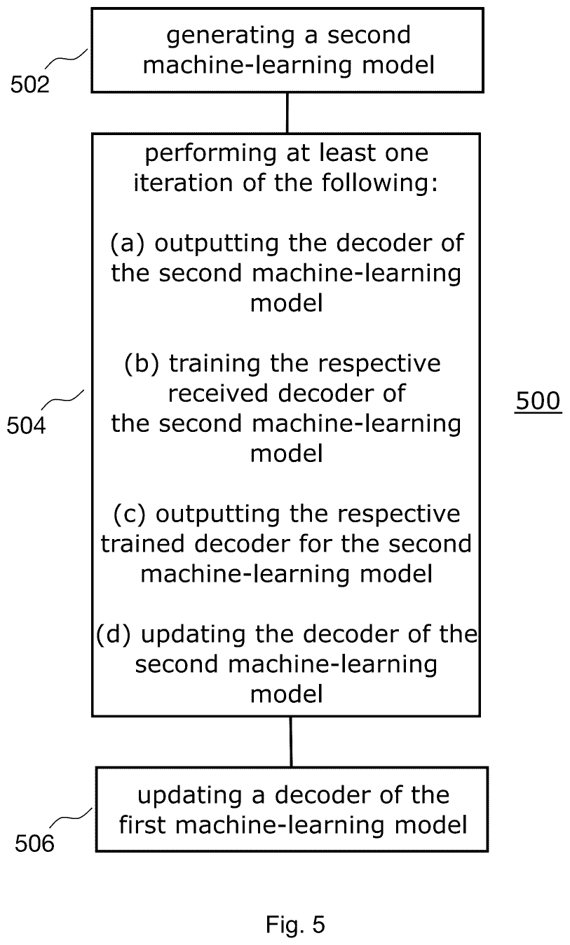

For further highlighting the interaction between the server or computing cloud and the one or more (e.g., edge) devices described above, FIG. 5 illustrates a flowchart of another method 500 for federated learning of a first machine-learning model. The method 500 comprises generating 502, at a server or computing cloud, a second machine-learning model from the first machine-learning model. The second machine-learning model is smaller than the first machine-learning model. The second machine-learning model comprises a backbone and a decoder. The method 500 further comprises performing 504 at least one iteration of the following: (a) outputting, by the server or computing cloud, the decoder of the second machine-learning model to a one or more devices and for the first iteration of the at least one iteration further outputting the backbone of the second machine-learning model to the one or more devices; (b) training the respective received decoder of the second machine-learning model locally at the one or more devices using local data at the respective device; (c) outputting, by the one or more devices, the respective trained decoder for the second machine-learning model to the server or computing cloud; and (d) updating, by the server or computing cloud, the decoder of the second machine-learning model based on the trained decoders received from the one or more devices. In addition, the method 500 comprises updating 506, by the server or computing cloud, a decoder of the first machine-learning model based on the updated decoder of the second machine-learning model.

Analogously to what is described above, the method 500 provides improved federated learning.

More details and aspects of the method 500 are explained in connection with the proposed technique or one or more examples described above (e.g., FIG. 1 and FIG. 2). The method 500 may comprise one or more additional optional features corresponding to one or more aspects of the proposed technique or one or more examples described above.

As described above, the first machine-learning model may be a foundation model. Accordingly, the first machine-learning model obtained by federated according to the proposed technology may be used for processing various types of data for various use cases. For example, the first machine-learning model obtained by federated according to the proposed technology may be used for processing one or more of image data, audio data and sensor data in various use cases such as, e.g., convenience store analysis or traffic monitoring. Accordingly, the present disclosure further relates to the use of the first machine-learning model obtained by federated according to the proposed technology for processing one or more of image data, audio data and sensor data. In other words, the present disclosure further relates to a method for processing one or more of image data, audio data and sensor data which comprises using the first machine-learning model obtained by federated according to the proposed technology. However, it is to be noted that the present disclosure is not limited thereto. More, less or different types of data (e.g., personal data) may be processed with the first machine-learning model obtained by federated according to the proposed technology. Similarly, the first machine-learning model obtained by federated according to the proposed technology may be used for use cases different from those mentioned above.

As a further example, the present disclosure finds applicability in server-hosted applications delivered by a network to a client device. These applications may be Software as a Service (SaaS) solutions. A provider offers the use of an application and is responsible for computing platforms through which the application runs or from which it is delivered. It will be appreciated that some or all of the platform may be owned by the provider or the provider may have a commercial relationship with a sub-provider for some or all of the computing platforms, for example storing data on cloud or other storage of the sub-provider. A user or user organization may be a subscriber to the service.

The application offered by the SaaS service provider may for example include or have available to it a database records such as human resource department records, sales or research and development data, intellectual property data, trade secrets, customer data but the disclosure is not so limited. Such data may be confidential or secret to a user or user organization. The application may perform functionality using a first machine-learning model such as for example but not limited to classifying data, summarizing data, ranking data, suggesting tasks to perform, predicting outcomes, ranking predicted outcomes, generating hypotheses, generating or deriving content or any combination thereof. It will be appreciated that a user or user organization of SaaS service may store confidential or secret information in data storage of the SaaS service or available to the SaaS service. This data may be protected by encryption, password, business rule, geo-location or other methods. It may be desirable for a user or user organization to use this data for training the first machine-learning model to provide the functionality which is more applicable related to the user or user organization, but without sharing the actual information to other entities or subscribers. The SaaS software application may interface with one or more first machine-learning models. The first machine-learning model may be a common machine-learning model applicable to all or some of the subscribers. A first machine-learning model may be provided for each user or user organization. The user organization may be a whole organization or a division of a whole organization, so for example a global organization may have multiple first machine-learning models which may or may not be accessible to users from all of the global organizations' users. Divisions may have their own first machine models which are not shared or available to other divisions.

A second machine-learning model generated from the first machine-learning model is provided to a client computing device of the user, user organization or to a client of the storage on which the user or user organization's confidential or secret data is stored. For example the software application may provide the client with a software module which receives the confidential or secret data or a processed version of it to train the decoder of the second machine-learning model. In some embodiments the confidential or secret data is data stored in another data repository, for example not connected with the SaaS service. In such embodiments the software module may format or process the data stored in another repository for training the decoder of the second machine-learning model to ensure compatibility. For example, the machine-learning module may include code components which form feature vector data from the confidential or secret data is data stored in another data repository or which can add or modify or delete nodes, layers or weights to a first machine-learning model.

The first machine-learning model, whether a common machine-learning model for more than one use or user organization or specific machine-learning model for a user or user organization is then updated using the decoder of the second machine-learning model as described above.

The following examples pertain to further embodiments:
(1) An apparatus for federated learning of a first machine-learning model, the apparatus comprising processing circuitry configured to:
   generate a second machine-learning model from the first machine-learning model, wherein the second machine-learning model is smaller than the first machine-learning model, and wherein the second machine-learning model comprises a backbone and a decoder;
   perform at least one iteration of the following (a) to (c):
      (a) output the decoder of the second machine-learning model to one or more devices and for the first iteration of the at least one iteration further output the backbone of the second machine-learning model to the one or more devices;
      (b) receive a trained version of a decoder for the second machine-learning model from the one or more devices; and
      (c) update the decoder of the second machine-learning model based on the trained version of the decoder received from the one or more devices; and
   update a decoder of the first machine-learning model based on the updated decoder of the second machine-learning model.
(2) The apparatus of (1), wherein the processing circuitry is further configured to iteratively perform (a) to (c) until the second machine-learning model with the updated decoder satisfies a predefined criterion.
(3) The apparatus of (1) or (2), wherein the processing circuitry is configured to update only the decoder of the first machine-learning model while keeping a backbone of the first machine-learning model unchanged.
(4) The apparatus of any one of (1) to (3), wherein the processing circuitry is configured to control the one or more devices to train only the decoder of the second machine-learning model locally at the one or more devices using local data at the respective device while keeping the backbone of the second machine-learning model unchanged.
(5) The apparatus of any one of (1) to (4), wherein the processing circuitry is configured to update the decoder of the first machine-learning model by replacing the decoder of the first machine-learning model with the updated decoder of the second machine-learning model.
(6) The apparatus of any of (1) to (5), wherein the processing circuitry is configured to generate the second machine-learning model from the first machine-learning model using knowledge distillation.
(7) The apparatus of (6), wherein the processing circuitry is configured to generate the second machine-learning model from the first machine-learning model using knowledge distillation by training the backbone of the second machine-learning model to minimize a loss function that measures the difference between output data of the backbone of the second machine-learning model and output data of a backbone of the first machine-learning model for the same input data.
(8) The apparatus of any one of (1) to (7), wherein the processing circuitry is configured to keep the first machine-learning model unchanged when generating the second machine-learning model.
(9) The apparatus of any one of (1) to (8), wherein the processing circuitry is configured to update the decoder of the first machine-learning model based on the updated decoder of the second machine-learning model obtained in the last iteration of the at least one iteration.
(10) The apparatus of any one of (1) to (9), wherein the second machine-learning model is smaller with respect to at least one of complexity, size and resource requirements compared to the first machine-learning model.
(11) The apparatus of any one of (1) to (10), wherein the first machine-learning model is a foundation model.
(12) A server or a computing cloud comprising the apparatus according to any one of (1) to (11).
(13) A device comprising processing circuitry configured to perform at least one iteration of the following:
   receive a decoder of a machine-learning model from a server or computing cloud, wherein a backbone of the machine-learning model is further received in the first iteration of the at least one iteration, and wherein the received decoder is an updated version of the received decoder compared to a previous iteration for the second and each further iteration of the at least one iteration;
   train the received decoder of the machine-learning model using local data at the device; and output the trained decoder for the machine-learning model to the server or computing cloud.
(14) The device of (13), wherein the processing circuitry is configured to train only the received decoder of the machine-learning model using the local data at the device while keeping the backbone of the machine-learning model unchanged.
(15) The device of (13) or (14), wherein the processing circuitry is configured to output only the trained decoder for the machine-learning model to the server or computing cloud.
(16) A method for federated learning of a first machine-learning model, the method comprising:
   generating a second machine-learning model from the first machine-learning model, wherein the second machine-learning model is smaller than the first machine-learning model, wherein the second machine-learning model comprises a backbone and a decoder; performing at least one iteration of the following (a) to (c):
      (a) outputting the decoder of the second machine-learning model to one or more devices and for the first iteration of the at least one iteration further outputting the backbone of the second machine-learning model to the one or more devices;
      (b) receiving a trained version of a decoder for the second machine-learning model from the one or more devices; and
      (c) updating the decoder of the second machine-learning model based on the trained version of the decoder received from the one or more devices; and
   updating a decoder of the first machine-learning model based on the updated decoder of the second machine-learning model.
(17) The method of (16), wherein the method is performed by a server or a computing cloud.
(18) The method of (16) or (17), wherein (a) to (c) are iteratively performed until the second machine-learning model with the updated decoder satisfies a predefined criterion.
(19) A method for a device, wherein the method comprises performing at least one iteration of the following:
   receiving a decoder of a machine-learning model from a server or computing cloud, wherein a backbone of the machine-learning model is further received in the first iteration of the at least one iteration, and wherein the received decoder is updated version of the received decoder compared to a previous iteration for the second and each further iteration of the at least one iteration;
   training the received decoder of the machine-learning model using local data at the device; and
   outputting the trained decoder for the machine-learning model to the server or computing cloud.
(20) The method of (19), wherein only the received decoder of the machine-learning model is trained using the local data at the device while the backbone of the machine-learning model is kept unchanged.
(21) A method for federated learning of a first machine-learning model, the method comprising:
   generating, at a server or computing cloud, a second machine-learning model from the first machine-learning model, wherein the second machine-learning model is smaller than the first machine-learning model, and wherein the second machine-learning model comprises a backbone and a decoder;
   performing at least one iteration of the following:
      outputting, by the server or computing cloud, the decoder of the second machine-learning model to one or more devices and for the first iteration of the at least one iteration further outputting the backbone of the second machine-learning model to the one or more devices;
      training the respective received decoder of the second machine-learning model locally at the one or more devices using local data at the respective device;
      outputting, by the one or more devices, the respective trained decoder for the second machine-learning model to the server or computing cloud; and
      updating, by the server or computing cloud, the decoder of the second machine-learning model based on the trained decoders received from the one or more devices; and
   updating, by the server or computing cloud, a decoder of the first machine-learning model based on the updated decoder of the second machine-learning model.
(22) The method of (21), wherein the second machine-learning model is generated from the first machine-learning model using knowledge distillation, and wherein the one or more devices train only the respective received decoder of the second machine-learning model while keeping the backbone of the second machine-learning model unchanged.
(23) Use of the first machine-learning model obtained by one of the methods according to any one of (16) to (18), (21) and (22) for processing image data.
(24) A method for processing image data which comprises using the first machine-learning model obtained by one of the methods according to any one of (16) to (18), (21) and (22).
(25) A non-transitory machine-readable medium having stored thereon a program having a program code for performing the method according to any one of (16) to (22), when the program is executed on a processor or a programmable hardware.
(26) A program having a program code for performing the method according to any one of claims (16) to (22), when the program is executed on a processor or a programmable hardware.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), ASICs, integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for federated learning of a first machine-learning model, the apparatus comprising processing circuitry configured to:
generate a second machine-learning model from the first machine-learning model, wherein the second machine-learning model is smaller than the first machine-learning model, and wherein the second machine-learning model comprises a backbone and a decoder;
perform at least one iteration of the following (a) to (c):
(a) output the decoder of the second machine-learning model to one or more devices and for the first iteration of the at least one iteration further output the backbone of the second machine-learning model to the one or more devices;
(b) receive a trained version of a decoder for the second machine-learning model from the one or more devices; and
(c) update the decoder of the second machine-learning model based on the trained version of the decoder received from the one or more devices; and
update a decoder of the first machine-learning model based on the updated decoder of the second machine-learning model.

2. The apparatus of claim 1, wherein the processing circuitry is further configured to iteratively perform (a) to (c) until the second machine-learning model with the updated decoder satisfies a predefined criterion.

3. The apparatus of claim 1, wherein the processing circuitry is configured to update only the decoder of the first machine-learning model while keeping a backbone of the first machine-learning model unchanged.

4. The apparatus of claim 1, wherein the processing circuitry is configured to control the one or more devices to train only the decoder of the second machine-learning model locally at the one or more devices using local data at the respective device while keeping the backbone of the second machine-learning model unchanged.

5. The apparatus of claim 1, wherein the processing circuitry is configured to update the decoder of the first machine-learning model by replacing the decoder of the first machine-learning model with the updated decoder of the second machine-learning model.

6. The apparatus of claim 1, wherein the processing circuitry is configured to generate the second machine-learning model from the first machine-learning model using knowledge distillation.

7. The apparatus of claim 6, wherein the processing circuitry is configured to generate the second machine-learning model from the first machine-learning model using knowledge distillation by training the backbone of the second machine-learning model to minimize a loss function that measures the difference between output data of the backbone of the second machine-learning model and output data of a backbone of the first machine-learning model for the same input data.

8. The apparatus of claim 1, wherein the processing circuitry is configured to keep the first machine-learning model unchanged when generating the second machine-learning model.

9. The apparatus of claim 1, wherein the processing circuitry is configured to update the decoder of the first machine-learning model based on the updated decoder of the second machine-learning model obtained in the last iteration of the at least one iteration.

10. The apparatus of claim 1, wherein the second machine-learning model is smaller with respect to at least one of complexity, size and resource requirements compared to the first machine-learning model.

11. The apparatus of claim 1, wherein the first machine-learning model is a foundation model.

12. A server or a computing cloud comprising the apparatus according to claim 1.

13. A device comprising processing circuitry configured to perform at least one iteration of the following:
receive a decoder of a machine-learning model from a server or computing cloud, wherein a backbone of the machine-learning model is further received in the first iteration of the at least one iteration, and wherein the received decoder is an updated version of the received decoder compared to a previous iteration for the second and each further iteration of the at least one iteration;
train the received decoder of the machine-learning model using local data at the device; and
output the trained decoder for the machine-learning model to the server or computing cloud.

14. The device of claim 13, wherein the processing circuitry is configured to train only the received decoder of the machine-learning model using the local data at the device while keeping the backbone of the machine-learning model unchanged.

15. The device of claim 13, wherein the processing circuitry is configured to output only the trained decoder for the machine-learning model to the server or computing cloud.

16. A method for federated learning of a first machine-learning model, the method comprising:
generating a second machine-learning model from the first machine-learning model, wherein the second machine-learning model is smaller than the first machine-learning model, wherein the second machine-learning model comprises a backbone and a decoder;
performing at least one iteration of the following (a) to (c):
(a) outputting the decoder of the second machine-learning model to one or more devices and for the first iteration of the at least one iteration further outputting the backbone of the second machine-learning model to the one or more devices;
(b) receiving a trained version of a decoder for the second machine-learning model from the one or more devices; and
(c) updating the decoder of the second machine-learning model based on the trained version of the decoder received from the one or more devices; and
updating a decoder of the first machine-learning model based on the updated decoder of the second machine-learning model.

17. The method of claim 16, wherein the method is performed by a server or a computing cloud.

18. The method of claim 16, wherein (a) to (c) are iteratively performed until the second machine-learning model with the updated decoder satisfies a predefined criterion.

19. A method for a device, wherein the method comprises performing at least one iteration of the following:
receiving a decoder of a machine-learning model from a server or computing cloud, wherein a backbone of the machine-learning model is further received in the first iteration of the at least one iteration, and wherein the received decoder is updated version of the received decoder compared to a previous iteration for the second and each further iteration of the at least one iteration;
training the received decoder of the machine-learning model using local data at the device; and
outputting the trained decoder for the machine-learning model to the server or computing cloud.

20. The method of claim 19, wherein only the received decoder of the machine-learning model is trained using the local data at the device while the backbone of the machine-learning model is kept unchanged.
